(19) United States
(12) Patent Application Publication
(10) Pub. No.: US 2023/0258191 A1
(43) Pub. Date: Aug. 17, 2023

(54) DRY VACUUM PUMP REGENERATION MECHANISM AND DRY VACUUM PUMP REGENERATION METHOD

(71) Applicant: Kioxia Corporation, Tokyo (JP)

(72) Inventors: Shogo Hosokai, Yokkaichi Mie (JP); Takayuki Saito, Yokkaichi Mie (JP); Yoshiaki Takahashi, Yokkaichi Mie (JP); Masanori Seki, Yokkaichi Mie (JP); Takayasu Ueno, Yokkaichi Mie (JP); Yuya Maruki, Yokkaichi Mie (JP)

(73) Assignee: Kioxia Corporation, Tokyo (JP)

(21) Appl. No.: 17/887,788

(22) Filed: Aug. 15, 2022

(30) Foreign Application Priority Data
Feb. 17, 2022 (JP) 2022-023028

(51) Int. Cl. F04D 23/00; F04D 25/16; F04D 27/00; F04D 29/40; F04D 29/58; F04D 29/70; B08B 5/04

(52) U.S. Cl. CPC F04D 23/008; F04D 25/16; F04D 27/008; F04D 29/403; F04D 29/582; F04D 29/701; B08B 5/04

(57) ABSTRACT

A dry vacuum pump regeneration apparatus includes an intake pipe connected to an intake port of a dry vacuum pump; an exhaust pipe connected to an exhaust port of the dry vacuum pump; an auxiliary vacuum pump configured to evacuate an interior of the dry vacuum pump upon being stopped via the exhaust pipe; a plasma generator configured to cause a first gas to pass through the plasma generator to generate a plasma in an atmosphere of the passing first gas, and release a radical of the first gas to the intake port via the intake pipe; a first gas heating device configured to cause a second gas to pass through the first gas heating device, heat the passing second gas, and release the heated second gas to the intake port via the intake pipe; and a bypass pipe connected to the intake pipe and the exhaust pipe.

### CROSS-REFERENCE TO RELATED APPLICATION(S)

This application is based upon and claims the benefit of priority from Japanese Patent Application No. 2022-023028, filed Feb. 17, 2022, the entire contents of which are incorporated herein by reference.

### FIELD

Embodiments described herein relate generally to a dry vacuum pump regeneration mechanism and a dry vacuum pump regeneration method.

### BACKGROUND

Non-contact type dry vacuum pumps that do not use oil or liquid for sealing are widely used in semiconductor manufacturing lines. Through such a dry vacuum pump, a clean vacuum state can be obtained without diffusing the oil or the liquid. For example, a film forming apparatus represented by a chemical vapor deposition (CVD) apparatus is evacuated by a dry vacuum pump. In the film forming apparatus, a raw material gas is introduced into a chamber to form a desired film on a substrate disposed in the chamber. The raw material gas remaining in the chamber is exhausted by the dry vacuum pump via an exhaust pipe. In this case, the dry vacuum pump may be disadvantageously stopped when a product generated due to the raw material gas is deposited in the dry vacuum pump. For example, an interior of a process chamber is evacuated by the dry vacuum pump not only in the film forming apparatus but also in other process apparatuses such as an etching apparatus represented by a dry etching apparatus. In this case, there is a disadvantage in that the dry vacuum pump may be stopped when a product generated due to a gas discharged from the process chamber is deposited in the dry vacuum pump.

In the related art, a technique for removing the product discharged from the film forming apparatus before the product is suctioned into the dry vacuum pump is disclosed. Further, it is typically difficult to restart the dry vacuum pump when the dry vacuum pump is once stopped.

### DESCRIPTION OF THE DRAWINGS

FIG. 1 is a view showing an example of an exterior of a pump regeneration mechanism according to a first embodiment.

FIG. 2 is a view showing an example of a configuration of the pump regeneration mechanism according to the first embodiment.

FIG. 3 is a view showing an example of a graph of a vapor pressure curve according to the first embodiment.

FIG. 4 is a flowchart showing an example of a main step of a pump regeneration method according to the first embodiment.

FIG. 5 is a view showing an example of an internal configuration of a heated nitrogen gas generator according to the first embodiment.

FIG. 6 is a view showing an example of a configuration of a dry vacuum pump according to the first embodiment.

FIG. 7 is a view showing an example of an internal configuration of a plasma generator according to the first embodiment.

FIG. 8 is a view showing an operation of a bypass pipe according to the first embodiment.

FIG. 9 is a sectional view showing an example of a configuration of a trap according to the first embodiment.

FIG. 10 is a sectional view showing an example of a configuration of an exhaust gas detoxifying device according to the first embodiment.

FIGS. 11A and 11B are views showing an example of a state of a casing and a rotor in the dry vacuum pump according to the first embodiment.

### DETAILED DESCRIPTION

In general, according to one embodiment, a dry vacuum pump regeneration apparatus is disclosed. The dry vacuum pump regeneration apparatus includes an intake pipe connected to an intake port of a dry vacuum pump; an exhaust pipe connected to an exhaust port of the dry vacuum pump; an auxiliary vacuum pump configured to evacuate an interior of the dry vacuum pump upon being stopped via the exhaust pipe; a plasma generator configured to cause a first gas to pass through the plasma generator to generate a plasma in an atmosphere of the passing first gas, and release a radical of the first gas generated by the plasma to the intake port of the stopped dry vacuum pump via the intake pipe; a first gas heating device configured to cause a second gas to pass through the first gas heating device, heat the passing second gas, and release the heated second gas to the intake port of the stopped dry vacuum pump via the intake pipe; and a bypass pipe connected to the intake pipe and the exhaust pipe without being connected to the dry vacuum pump.

### First Embodiment

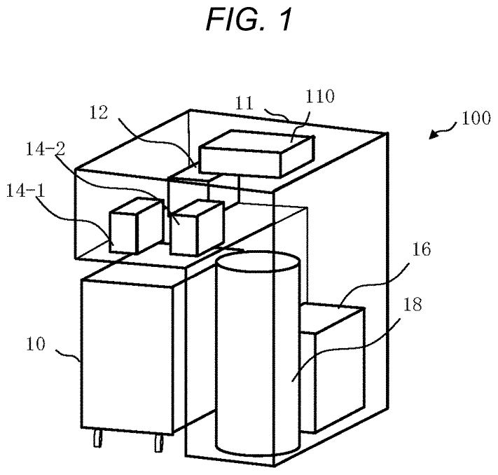

FIG. 1 is a view showing an example of an exterior of a pump regeneration mechanism (or apparatus) according to a first embodiment. In FIG. 1, a pump regeneration mechanism 100 is an example of a dry vacuum pump regeneration mechanism. The pump regeneration mechanism 100 includes a control circuit 110, a plasma generator 12, heated nitrogen gas generators 14-1 and 14-2, an auxiliary vacuum pump 16, and an exhaust gas detoxifying device 18. In the pump regeneration mechanism 100, the plasma generator 12, the heated nitrogen gas generators 14-1 and 14-2, the auxiliary vacuum pump 16, and the exhaust gas detoxifying device 18 are disposed in a frame 11.

In the example in FIG. 1, the plasma generator 12, the heated nitrogen gas generators 14-1 and 14-2, the auxiliary vacuum pump 16, and the exhaust gas detoxifying device 18 are disposed in the frame 11 that covers a dry vacuum pump 10 serving as a regeneration target. For example, the auxiliary vacuum pump 16 is disposed on a side surface on an exhaust port side of the dry vacuum pump 10 serving as the regeneration target. For example, the exhaust gas detoxifying device 18 is disposed adjacent to the auxiliary vacuum pump 16. For example, the plasma generator 12 and the heated nitrogen gas generators 14-1 and 14-2 are disposed above the dry vacuum pump 10 serving as the regeneration target. In addition, for example, the control circuit 110 is disposed on the frame 11. In this way, each device is disposed in the frame 11 that covers the dry vacuum pump 10 serving as the regeneration target. Therefore, a compact layout for the pump regeneration mechanism 100 is available.

For example, the dry vacuum pump 10 is used for evacuating an interior of a process chamber so that the interior of the process chamber is controlled in a state having a pressure lower than an atmospheric pressure in a film forming apparatus represented by a chemical vapor deposition (CVD) apparatus, an etching apparatus represented by a dry etching apparatus, or other process apparatuses. In this case, a product generated due to a gas discharged from the process chamber is deposited in the dry vacuum pump 10, and the dry vacuum pump 10 is stopped. For example, a silane (SiH₄)-based gas is introduced as a main raw material gas to form a silicon oxide film (SiO film) or a silicon nitride film (SiN film). In addition, for example, a tetraethoxysilane (TEOS) gas is introduced as a main raw material gas to form a silicon oxide film (SiO film). When the films are formed, the product generated due to the raw material gas is deposited not only in a film forming chamber but also in the dry vacuum pump 10 via the exhaust pipe. For example, in addition to the silicon oxide film, the product deposited in the dry vacuum pump 10 includes a sulfuric acid-based compound such as ammonium sulfate, or an ether-based compound.

For example, in many cases, the dry vacuum pumps 10 adopting a root or screw type are used for a high load process in which the product is deposited. In the dry vacuum pumps 10, a rotor rotates in a casing to feed the internal gas to the exhaust port side. This process is repeatedly performed to generate a vacuum state on the intake port side. To prevent a backflow of the gas, a gap (clearance) between the rotor and the casing is controlled to a small dimension on a submillimeter order, for example, several tens of pm to several hundreds of pm. Therefore, when the product is deposited in the dry vacuum pump 10, the gap between the rotor and the casing is filled with the deposited product, thereby bringing the gap into a closed state. When the gap is brought into the closed state, a motor that rotates the rotor enters an overloaded state, and the dry vacuum pump 10 is stopped.

In the related art, the dry vacuum pump stopped due to the deposited product is delivered to a pump manufacturer for carrying out an overhaul to remove the internally deposited product. While many dry vacuum pumps are used in semiconductor manufacturing lines, many dry vacuum pumps are stopped. Consequently, huge overhaul costs are required. Therefore, it is desirable that the stopped dry vacuum pump can be restarted without carrying out the overhaul. Therefore, according to the first embodiment, the dry vacuum pump 10 stopped due to the deposited product is detached from the exhaust pipe which is continuous from the process chamber, and is attached to the pump regeneration mechanism 100. In other words, the dry vacuum pump 10 stopped due to the deposited product is detached from the semiconductor manufacturing line, and is attached to the pump regeneration mechanism 100. The dry vacuum pump 10 brought into a non-startable state is regenerated to be startable by the pump regeneration mechanism 100. Hereinafter, specific description will be continued.

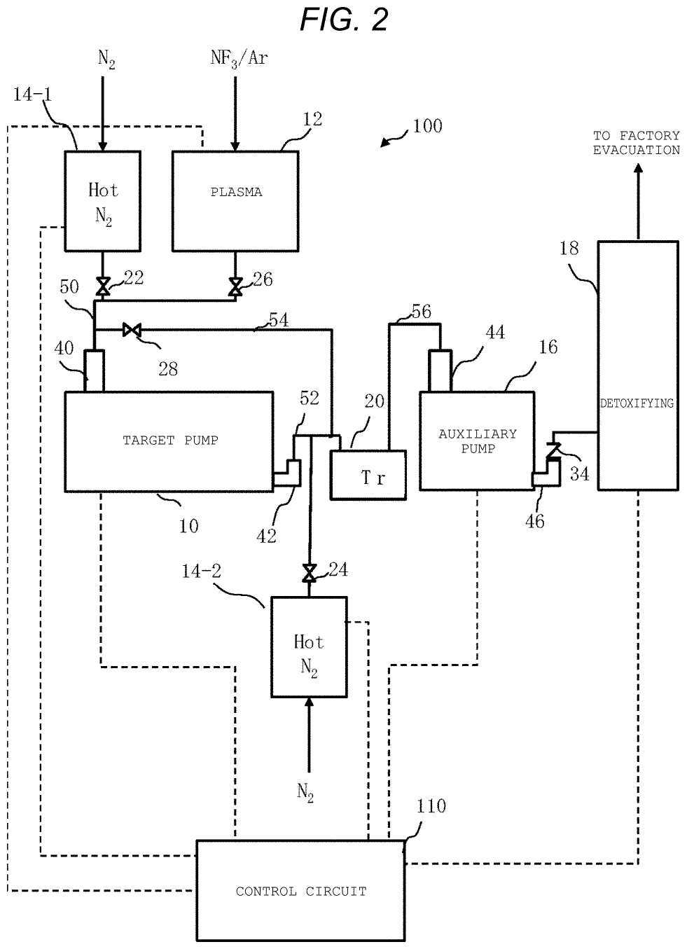

FIG. 2 is a view showing an example of a configuration of the pump regeneration mechanism according to the first embodiment. In the pump regeneration mechanism 100 according to the first embodiment, as shown in FIG. 2, an intake pipe 50 is connected to an intake port 40 of the dry vacuum pump 10 stopped due to the deposit deposited in the dry vacuum pump 10. In addition, an exhaust pipe 52 is connected to an exhaust port 42 of the dry vacuum pump 10. In addition, the auxiliary vacuum pump 16 is connected to the stopped dry vacuum pump 10 via the exhaust pipe 52 and an exhaust pipe 56. The example in FIG. 2 shows a case where a trap 20 is disposed between the exhaust port 42 of the dry vacuum pump 10 and an intake port 44 of the auxiliary vacuum pump 16. A configuration may be adopted so that the trap 20 is omitted. In the example in FIG. 2, the other end of the exhaust pipe 52 whose one end is connected to the exhaust port 42 of the dry vacuum pump 10 is connected to an intake port of the trap 20, and one end of the exhaust pipe 56 is connected to an exhaust port of the trap 20. The other end of the exhaust pipe 56 is connected to the intake port 44 of the auxiliary vacuum pump 16.

Furthermore, the exhaust gas detoxifying device 18 is disposed on the exhaust port 46 side of the auxiliary vacuum pump 16. A check valve 34 is disposed in the exhaust port 46 of the auxiliary vacuum pump 16 to prevent a backflow of the gas.

In addition, the heated nitrogen gas generator 14-1 (first gas heating device) is connected to the intake pipe 50 via a valve 22. In addition, the plasma generator 12 is further connected to the intake pipe 50 via a valve 26. On the other hand, the heated nitrogen gas generator 14-2 (second gas heating device) is connected to the exhaust pipe 52 via a valve 24. In other words, the heated nitrogen gas generator 14-1 is connected to the intake port 40 of the stopped dry vacuum pump 10 via the intake pipe 50. The heated nitrogen gas generator 14-2 is connected to the exhaust port 42 of the stopped dry vacuum pump 10 via the exhaust pipe 52. The plasma generator 12 is connected to the intake port 40 of the stopped dry vacuum pump 10 via the intake pipe 50.

In addition, a bypass pipe 54 connects the intake pipe 50 and the exhaust pipe 52 without involvement of the dry vacuum pump 10. A differential exhaust valve 28 is disposed in an intermediate portion of the bypass pipe 54. A flow control valve may be used instead of the differential exhaust valve 28.

In addition, the control circuit 110 that controls the whole pump regeneration mechanism 100 is connected to each control circuit of the plasma generator 12, the heated nitrogen gas generators 14-1 and 14-2, the auxiliary vacuum pump 16, and the exhaust gas detoxifying device 18 to be communicable (dotted line). In addition, although not shown, the control circuit 110 is connected to each of the valves 22, 24, and 26. The control circuit 110 may be connected to the differential exhaust valve 28 (or the flow control valve). In addition, the control circuit 110 is connected to the control circuit of the dry vacuum pump 10 serving as a regeneration target to be communicable.

The control circuit 110 controls the plasma generator 12, the heated nitrogen gas generators 14-1 and 14-2, the auxiliary vacuum pump 16, and the exhaust gas detoxifying device 18. In addition, the control circuit 110 controls opening and closing of each of the valves 22, 24, and 26. The control circuit 110 may control a differential pressure (or an opening degree) of the differential exhaust valve 28 (or the flow control valve). In addition, the control circuit 110 is configured to transmit a start/stop signal of the dry vacuum pump 10 stopped due to product adhesion.

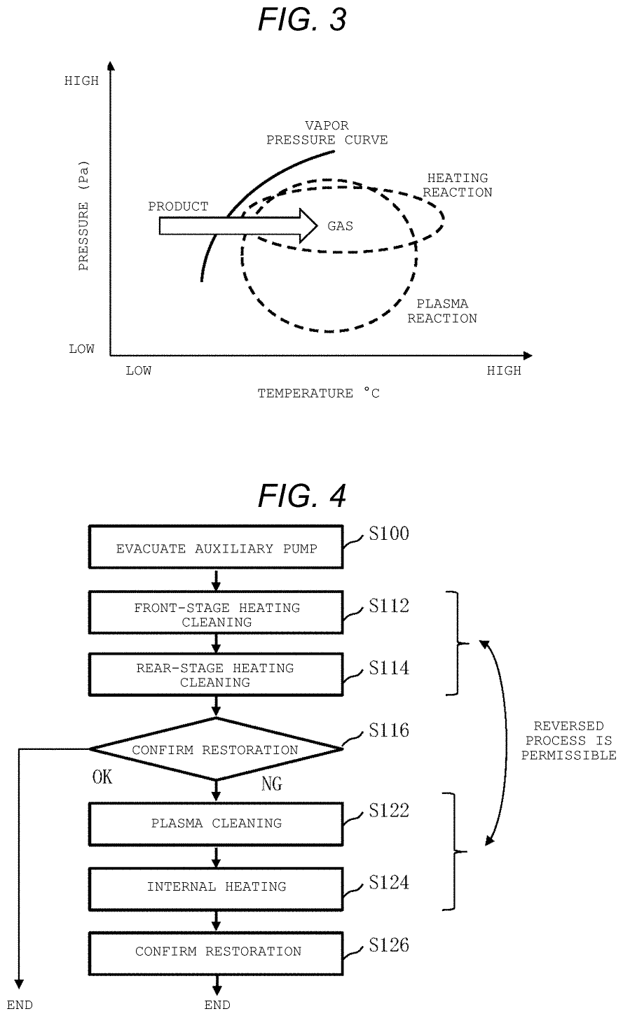

FIG. 3 is a view showing an example of a graph of a vapor pressure curve according to the first embodiment. In FIG. 3, a vertical axis represents a pressure (Pa). A horizontal axis represents a temperature (° C.). Various products deposited on the dry vacuum pump 10 exist as a solid under left side conditions of the vapor pressure curve. The products are sublimated and gasified under right side conditions of the vapor pressure curve. Specifically, under each pressure, as the temperature is lower, the products are likely to be solidified, and as the temperature is higher, the products are likely to be gasified. According to the first embodiment, this phenomenon is used to control the pressure and the temperature in accordance with the vapor pressure curve of the deposited product. In this manner, the product deposited in the dry vacuum pump 10 is sublimated and discharged (heating cleaning). In addition, according to the first embodiment, the product deposited in the dry vacuum pump 10 is decomposed and discharged by a plasma reaction (plasma cleaning). One or both of the heating cleaning process and the plasma cleaning process are performed to discharge the product deposited in the dry vacuum pump 10 from the dry vacuum pump 10 to such an extent that the dry vacuum pump 10 can be restarted.

FIG. 4 is a flowchart showing an example of a main step of a pump regeneration method according to the first embodiment. In FIG. 4, in the pump regeneration method according to the first embodiment, a series of steps including an auxiliary pump evacuation step (S100), a front-stage heating cleaning step (S112), a rear-stage heating cleaning step (S114), a restoration confirmation step (S116), a plasma cleaning step (S122), an internal heating step (S124), and a restoration confirmation step (S126) are performed.

Although FIG. 4 shows an example where the heating cleaning process such as the front-stage heating cleaning step (S112) and the rear-stage heating cleaning step (S114) is performed before the plasma cleaning process such as the plasma cleaning step (S122) and the internal heating step (S124), the embodiment is not limited thereto. The plasma cleaning process such as the plasma cleaning step (S122) and the internal heating step (S124) may be performed before the heating cleaning process such as the front-stage heating cleaning step (S112) and the rear-stage heating cleaning step (S114). Alternatively, when the dry vacuum pump 10 can be restarted by the cleaning process performed earlier, the cleaning process subsequent thereto may be omitted.

As the auxiliary pump evacuation step (S100), the auxiliary vacuum pump 16 evacuates an interior of the stopped dry vacuum pump 10 via the exhaust pipes 52 and 56. As shown in FIG. 2, the interior of the dry vacuum pump 10 may be evacuated via the trap 20 between the exhaust pipes 52 and 56.

Here, in a closed state where a gap between a rotor and a casing is filled with the product, an upstream side and a downstream side of a closed location may be completely blocked, or a location through which the gas can pass without blocking the upstream side and the downstream side may exist in the vicinity of the closed location. When the location through which the gas can pass without blocking the upstream side and the downstream side exists, the intake port 40 of the dry vacuum pump 10 is evacuated by the auxiliary vacuum pump 16. When the upstream side and the downstream side are completely blocked, the downstream side of the completely blocked location of the dry vacuum pump 10 is evacuated by the auxiliary vacuum pump 16.

As the front-stage heating cleaning step (S112), first, the control circuit 110 controls the valve 22 to be opened from a state where the valves 22, 24, and 26 are closed. Under the control of the control circuit 110, the heated nitrogen gas generator 14-1 causes an inert gas to pass through the heated nitrogen gas generator 14-1, heats the passing inert gas, and releases the heated inert gas to the intake port 40 of the stopped dry vacuum pump 10 via the intake pipe 50.

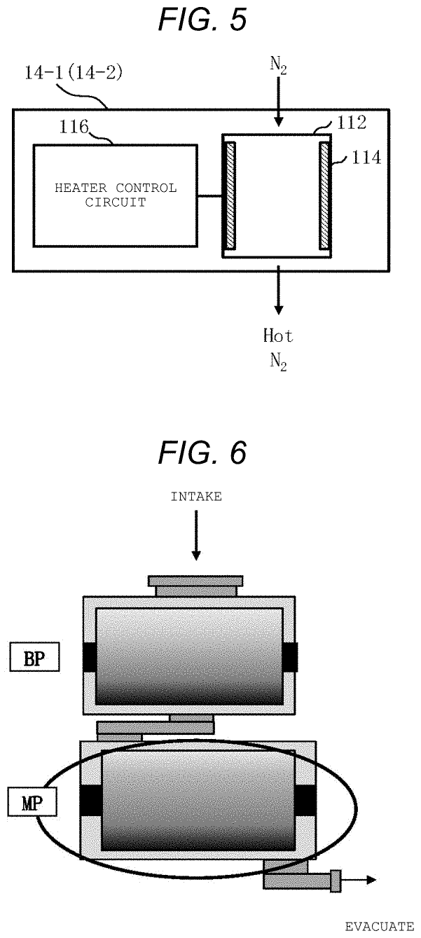

FIG. 5 is a view showing an example of an internal configuration of the heated nitrogen gas generator according to the first embodiment. In FIG. 5, the heated nitrogen gas generator 14-1 (14-2) includes a pipe 112, a heater 114, and a heater control circuit 116. For example, the heater 114 is disposed in the pipe 112. The inert gas is supplied to the heated nitrogen gas generator 14-1 from the outside of the pump regeneration mechanism 100. For example, as the inert gas, a nitrogen (N₂) gas or an argon (Ar) gas is preferably used. Hereinafter, for example, a case of using the N₂ gas will be described. The supplied N₂ gas passes through the pipe 112. Under the control of the heater control circuit 116, the heater 114 heats the N₂ gas passing through the inside of the pipe 112, and the heated N₂ gas (Hot N₂ gas) is released from an outlet of the pipe 112. The released Hot N₂ gas is supplied to the intake port 40 of the dry vacuum pump 10. Here, a heating temperature may be set to a sublimating temperature in accordance with the vapor pressure curve of the deposited product. For example, it is preferable to set the temperature to approximately 200° C. to 300° C.

The Hot N₂ gas enters the dry vacuum pump 10 from the intake port 40 of the dry vacuum pump 10, and raises an internal temperature of the dry vacuum pump 10. In this manner, the product deposited in the dry vacuum pump 10 is sublimated. Here, when the pressure on the intake port 40 side of the dry vacuum pump 10 is equal to or higher than a preset pressure due to the supplied Hot N₂ gas, the differential exhaust valve 28 is opened, and the gas is evacuated by the auxiliary vacuum pump 16 via the bypass pipe 54. In this manner, it is possible to maintain a pressure state where the deposited product can be sublimated in accordance with the vapor pressure curve of the deposited product.

Due to the entrance of the Hot N₂ gas from the intake port 40 of the dry vacuum pump 10, the product deposited in the dry vacuum pump 10 is sublimated gradually from the intake port 40 side toward the exhaust port 42 side. For example, in a closed state where the upstream side and the downstream side are completely blocked in the dry vacuum pump 10, the product in the closed location can be sublimated by heating the product with the Hot N₂ gas entering from the intake port 40. The sublimated gas is exhausted by the auxiliary vacuum pump 16 via the bypass pipe 54. In this manner, a completely blocked state can be changed to a state where the gas can pass therethrough (ventilation state). In the state where the gas can pass therethrough, the product can be further progressively sublimated toward the exhaust port 42 side.

In addition, in some cases, depending on a type of the deposited product, a temperature which enables the product to be sublimated may exist even in a state of an atmospheric pressure within a temperature range of the Hot N₂ gas that can be generated by the heated nitrogen gas generator 14-1 (14-2). In this case, when the Hot N₂ gas having a temperature equal to or higher than the temperature which enables the product to be sublimated is supplied, the deposited product can be sublimated even in the state of the atmospheric pressure.

After the front-stage heating cleaning step (S112) is performed for a preset time, the process proceeds to the rear-stage heating cleaning step (S114). For example, the step is performed for approximately 1 to 5 hours.

FIG. 6 is a view showing an example of a configuration of the dry vacuum pump according to the first embodiment. The example in FIG. 6 shows the dry vacuum pump 10 having a two-stage configuration including a booster pump (BP) serving as a front stage pump and a main pump (MP) serving as a rear stage pump. The product may be deposited in both the booster pump (BP) and the main pump (MP). The product deposited in the booster pump (BP) is removed from the intake side of the dry vacuum pump 10. In this case, when the product deposited in the booster pump (BP) is sublimated, it is considered that a portion of the liquefied product flows to the main pump (MP) side disposed below, and adheres to an intermediate connection pipe. Therefore, when the product is sublimated in the order of the rear stage and the front stage, there is a possibility that heating cleaning in the rear stage may be performed again. In contrast, the product can be efficiently sublimated by performing the heating cleaning in the order of the front stage and the rear stage. Therefore, according to the first embodiment, it is preferable to perform the front-stage heating cleaning step (S112) before the rear-stage heating cleaning step (S114), on an assumption that the product is deposited in the booster pump (BP).

As the rear-stage heating cleaning step (S114), the control circuit 110 closes the valve 22, and opens the valve 24. Then, under the control of the control circuit 110, the heated nitrogen gas generator 14-2 causes the inert gas to pass through the heated nitrogen gas generator 14-2 independently of the heated nitrogen gas generator 14-1, heats the passing inert gas, and releases the heated inert gas to the exhaust port 42 of the stopped dry vacuum pump 10 via the exhaust pipe 52.

The inert gas is supplied to the heated nitrogen gas generator 14-2 from the outside of the pump regeneration mechanism 100. For example, as the inert gas, it is preferable to use the N₂ gas or the Ar gas. Hereinafter, for example, a case of using the N₂ gas will be described. The supplied N₂ gas passes through the pipe 112 as shown in FIG. 5. Under the control of the heater control circuit 116, the heater 114 heats the N₂ gas passing through the inside of the pipe 112, and the heated N₂ gas (Hot N₂ gas) is released from an outlet of the pipe 112. The released Hot N₂ gas is supplied to the exhaust port 42 of the dry vacuum pump 10. Here, a heating temperature may be set to a sublimating temperature in accordance with the vapor pressure curve of the deposited product. For example, it is preferable to set the temperature to approximately 200° C. to 300° C.

The Hot N₂ gas enters the dry vacuum pump 10 from the exhaust port 42 of the dry vacuum pump 10, and raises the internal temperature of the dry vacuum pump 10. In this manner, the product deposited in the dry vacuum pump 10 is sublimated. The exhaust port 42 side of the dry vacuum pump 10 is evacuated by the auxiliary vacuum pump 16. Therefore, it is possible to maintain a pressure state where the deposited product can be sublimated in accordance with the vapor pressure curve of the deposited product.

Due to the entrance of the Hot N₂ gas from the exhaust port 42 of the dry vacuum pump 10, the product deposited in the dry vacuum pump 10 is sublimated gradually from the exhaust port 42 side toward the intake port 40 side. For example, when the closed state where the upstream side and the downstream side are completely blocked in the dry vacuum pump 10 cannot be resolved by the front-stage heating cleaning step (S112), the product in the closed location can be sublimated by heating the product with the Hot N₂ gas entering from the exhaust port 42. The sublimated gas is exhausted by the auxiliary vacuum pump 16. In this manner, a completely blocked state can be changed to a state where the gas can pass therethrough (ventilation state). In the state where the gas can pass therethrough, the product can be further progressively sublimated toward the intake port 40 side, even when there exists the product that cannot be removed by the front-stage heating cleaning step (S112).

After the rear-stage heating cleaning step (S114) is performed for a preset time, the process proceeds to the restoration confirmation step (S116). For example, the step is performed for approximately 1 to 5 hours.

As the restoration confirmation step (S116), the control circuit 110 transmits a start signal to the dry vacuum pump 10 in a state where a power cable is connected to the dry vacuum pump 10 to supply power. Alternatively, an operator turns on a start switch of the dry vacuum pump 10. In this manner, the operator confirms whether the dry vacuum pump 10 is restarted. In this case, the operator may insert a tool from the outside into a rotary shaft end of a rotor of the dry vacuum pump 10, may manually perform a rotating operation of a rotor of a booster pump, and may confirm that the rotor is rotated. Similarly, the operator may manually perform a rotating operation of a rotor of a main pump, and may confirm that the rotor is rotated. Thereafter, the operator may restart the dry vacuum pump 10. When the dry vacuum pump 10 is restarted, the operator completes the process as regeneration completion. When the dry vacuum pump 10 is not restarted, and is in an overloaded state, the process proceeds to the plasma cleaning step (S122).

The control circuit 110 performs control for switching between the heating cleaning process for releasing the heated inert gas to the stopped dry vacuum pump 10 and the plasma cleaning process for releasing the radical of the component of the cleaning gas to the stopped dry vacuum pump 10. Here, the control for switching the heating cleaning process to the plasma cleaning process is performed.

As the plasma cleaning step (S122), first, the control circuit 110 closes the valves 22 and 24, and opens the valve 26. Under the control of the control circuit 110, the plasma generator 12 causes the cleaning gas to pass through the plasma generator 12, generates the plasma in the atmosphere of the passing cleaning gas, and releases the radical of the component of the cleaning gas generated by the plasma to the intake port 40 of the stopped dry vacuum pump 10 via the intake pipe 50.

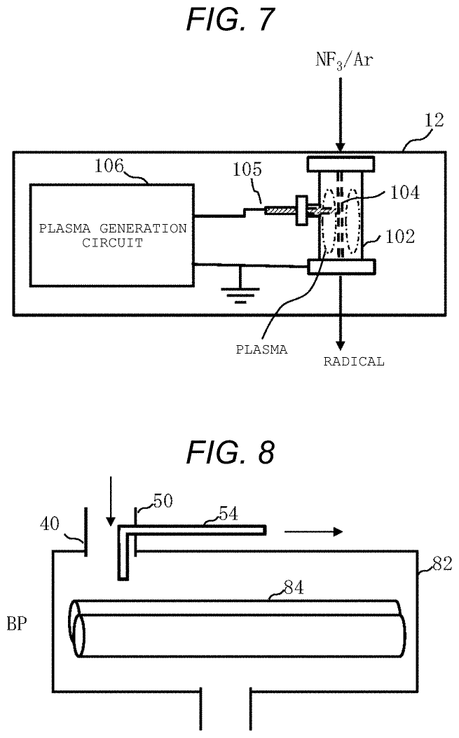

FIG. 7 is a view showing an example of an internal configuration of the plasma generator according to the first embodiment. In FIG. 7, the plasma generator 12 includes a pipe 102 formed of a conductive material, an internal electrode 104 formed of a conductive material, and a plasma generation circuit 106. For example, the internal electrode 104 is disposed in the pipe 102. For example, the internal electrode 104 is formed in a pipe shape. For example, a cross section of the internal electrode 104 is formed in a circular shape similar to that of the pipe 102. An introduction terminal 105 is introduced into the pipe 102 from an introduction terminal port connected to an outer peripheral surface of the pipe 102, and the introduction terminal 105 is connected to the internal electrode 104.

The cleaning gas such as an NF₃ gas is supplied to the plasma generator 12 from the outside of the plasma generator 12. In addition to the NF₃ gas, the Ar gas is supplied together as a diluent gas. The cleaning gas passes through the inside of the pipe 102. The plasma generation circuit 106 generates the plasma in the atmosphere of the passing cleaning gas. Specifically, the plasma generation circuit 106 uses a body of the pipe 102 as a grounded ground electrode, and applies a high frequency (RF) electric field to the internal electrode 104 via the introduction terminal 105 to apply a high frequency voltage between the internal electrode 104 and the pipe 102 (ground electrode). In this manner, the plasma (capacitively coupled plasma: CCP) is generated in a space between the internal electrode 104 and the pipe 102. The cleaning gas such as the NF₃ gas supplied from the upstream side is used to generate an F-radical by using the plasma. The generated F-radical is released to the intake port 40 of the dry vacuum pump 10 via the intake pipe 50. The F-radical decomposes the product deposited in the dry vacuum pump 10. In this manner, high cleaning performance can be achieved in the dry vacuum pump 10. A reaction formula of the NF₃ gas can be expressed in Formula (1) below.

2NF₃→6F*+N₂ (1)

In addition, the reaction formula with the product can be expressed in Formula (2) below.

F*+SiO₂→SiF₄+O₂ (2)

For example, SiF₄ generated after the deposit is decomposed by the F-radical is highly volatile. Accordingly, the dry vacuum pump 10 is evacuated by the auxiliary vacuum pump 16 through the exhaust pipe 52.

FIG. 8 is a view showing an operation of a bypass pipe according to the first embodiment. An example in FIG. 8 shows the booster pump (BP) and the vicinity of the intake port 40. A bypass pipe 54 may be bent in the intake pipe 50, and may be inserted into a casing 82 through the intake port 40. It is more preferable that the bypass pipe 54 extends to a portion close to a rotor 84 in the casing 82. In this manner, the bypass pipe 54 can be differentially evacuated at a pressure in the vicinity of the rotor 84 to which the product adheres.

In the plasma cleaning, the pressure in the state where NF₃ and Ar flow is controlled to a low pressure atmosphere where the plasma can be generated. When the bypass pipe 54 is not provided, the pressure may rise, thereby causing a possibility that the plasma may not be generated. Therefore, a stable pressure band can be maintained by differentially evacuating the bypass pipe 54. Since the stable pressure band is maintained, it is possible to maintain a state where the plasma does not have accidental fire.

Here, the product sublimated by the above-described heating cleaning and the product decomposed by the plasma cleaning are discharged from the dry vacuum pump 10 through an evacuation operation performed by the auxiliary vacuum pump 16. The gas containing the component of the discharged product passes through the trap 20. The trap 20 collects the deposit from a discharge discharged from the stopped dry vacuum pump 10.

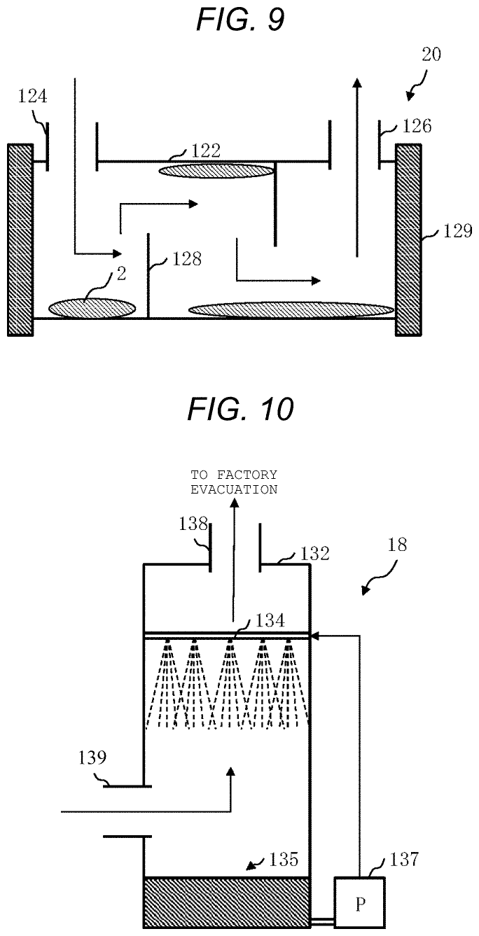

FIG. 9 is a sectional view showing an example of a configuration of the trap according to the first embodiment. In the example in FIG. 9, the trap 20 includes a tubular main body 122, an intake port 124, and an exhaust port 126. The inside of the main body 122 is adjusted by a partition plate 128 so that a flow path is lengthened. Since the flow path is lengthened, it is possible to increase an area of an inner wall of the main body 122 and the partition plate 128 with which the entering gas comes into contact. A flow velocity of the gas can be decreased by increasing an inner diameter of the main body 122 than that of the exhaust pipe 52. The gas passing through the inside of the trap 20 is cooled by coming into contact with the inner wall of the main body 122 and the partition plate 128 in the trap 20. In this manner, a product 2 is solidified and deposited in the trap 20. Therefore, the amount of the product moving to the auxiliary vacuum pump 16 side can be reduced. The product 2 deposited in the trap 20 can be removed by detaching flanges 129 on both sides of the main body 122 and cleaning the inside of the trap 20. In this manner, the trap 20 can be reused.

In addition, the gas exhausted from the auxiliary vacuum pump 16 moves forward to the exhaust gas detoxifying device 18. The exhaust gas detoxifying device 18 detoxifies the gas discharged from the dry vacuum pump 10 via the auxiliary vacuum pump 16.

FIG. 10 is a sectional view showing an example of a configuration of the exhaust gas detoxifying device according to the first embodiment. The example in FIG. 10 shows an example of a wet type of the exhaust gas detoxifying device 18 using a water scrubber. A solution (or liquid) 135, for example, water is stored in a lower portion of a main body 132. The solution 135 stored in the lower portion of the main body 132 is pumped up by a pump 137, and is delivered to a shower head 134 above the main body 132. The exhaust gas introduced from an intake port 139 on a side surface of the main body 132 moves forward to an upper exhaust port 138 while being showered with the solution 135 released from the shower head 134 in the main body 132. In this manner, it is possible to remove fine particles in the exhaust gas and detoxify other harmful gases. The exhaust gas detoxifying device 18 is not limited to the wet type, and may be another type of the detoxifying device. The detoxified gas exhausted from the exhaust port 138 moves forward to a factory evacuation facility.

After the plasma cleaning step (S122) is performed for a preset time, the process proceeds to the internal heating step (S124). For example, the step is performed for approximately 1 to 5 hours.

As the internal heating step (S124), the control circuit 110 closes the valve 26, and opens the valve 22. Under the control of the control circuit 110, the heated nitrogen gas generator 14-1 releases the heated inert gas (Hot N₂ gas) to the intake port 40 of the stopped dry vacuum pump 10 via the intake pipe 50. In this manner, the inside of the dry vacuum pump 10 is heated by the Hot N₂ gas.

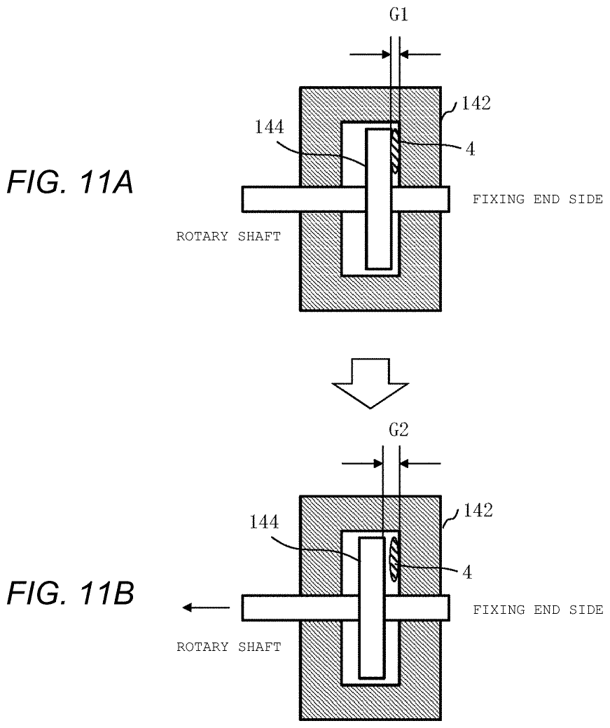

FIGS. 11A and 11B are views showing an example of a state of a casing and a rotor in the dry vacuum pump according to the first embodiment. The example in FIGS. 11A and 11B shows one of multi-stage rotors in a root type of the dry vacuum pump 10. For example, a gap (clearance) between a rotor 144 and a casing 142 is controlled to have a small dimension of a submillimeter order. The clearance is controlled to have the dimension in a state that the rotor 144 and the casing 142 are sufficiently warmed after the operation of the dry vacuum pump 10 starts. A rotary shaft that rotates the rotor 144 thermally expands. Therefore, as shown in FIG. 11A, the rotor 144 is disposed closer to a fixing end side of the rotary shaft at a room temperature. In this manner, a clearance G1 between a wall surface of the casing 142 and a side surface of the rotor 144 is in a narrower state than that during a normal operation. After the plasma cleaning, when a product 4 still adheres to and closes the narrow location, the dry vacuum pump 10 may not be restarted. Therefore, the Hot N₂ gas is caused to flow to heat the rotor 144 and the casing 142, and the temperature is raised to be higher than the temperature after the plasma cleaning. In this manner, the rotary shaft thermally expands. As shown in FIG. 11B, the clearance between the wall surface of the casing 142 and the side surface of the rotor 144 can be a clearance G2 wider than the clearance G1. Therefore, even when the product 4 remains, a space can be formed between the rotor 144 and the casing 142. In this state, the restoration confirmation step (S126) is performed.

As the restoration confirmation step (S126), it is confirmed whether or not to restart the dry vacuum pump 10 in the same manner as in the restoration confirmation step (S116). When the dry vacuum pump 10 is restarted, the operator completes the process as regeneration completion.

As described above, the dry vacuum pump 10 stopped due to the deposit deposited in the dry vacuum pump 10 can be regenerated to be restartable.

When the dry vacuum pump 10 is not restarted, the process may return to the heating cleaning process, and the steps subsequent to the front-stage heating cleaning step (S112) may be performed again.

As described above, according to the first embodiment, the stopped dry vacuum pump 10 can be restarted without carrying out the overhaul.

Hitherto, the embodiments have been described with reference to specific examples. However, the present disclosure is not limited to the specific examples. For example, in the above-described example, although the two heated nitrogen gas generators 14-1 and 14-2 are used, the Hot N₂ gas generated by one heated nitrogen gas generator 14-1 may be bifurcated and used by two systems.

In addition, although a heating method by supplying the Hot N₂ gas has been described in the internal heating step (S124), the embodiment is not limited thereto. For example, the heating may be performed by a heater (for example, a jacket heater) from the outside of the casing.

In addition, all of the dry vacuum pump regeneration mechanism and the dry vacuum pump regeneration method which include elements of the present disclosure and may be appropriately redesigned by those skilled in the art are included in the scope of the present disclosure.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A dry vacuum pump regeneration apparatus, comprising:
an intake pipe connected to an intake port of a dry vacuum pump;
an exhaust pipe connected to an exhaust port of the dry vacuum pump;
an auxiliary vacuum pump configured to evacuate an interior of the dry vacuum pump upon being stopped via the exhaust pipe;
a plasma generator configured to cause a first gas to pass through the plasma generator to generate a plasma in an atmosphere of the passing first gas, and release a radical of the first gas generated by the plasma to the intake port of the stopped dry vacuum pump via the intake pipe;
a first gas heating device configured to cause a second gas to pass through the first gas heating device, heat the passing second gas, and release the heated second gas to the intake port of the stopped dry vacuum pump via the intake pipe; and
a bypass pipe connected to the intake pipe and the exhaust pipe without being connected to the dry vacuum pump.

2. The dry vacuum pump regeneration apparatus according to claim 1,
wherein the auxiliary vacuum pump, the plasma generator, and the first gas heating device are accommodated in a frame.

3. The dry vacuum pump regeneration apparatus according to claim 1, further comprising:
a trap disposed in the exhaust pipe and configured to collect a deposit from a discharge discharged from the stopped dry vacuum pump.

4. The dry vacuum pump regeneration apparatus according to claim 3,
wherein the bypass pipe is connected to the exhaust pipe on a side of the exhaust port of the dry vacuum pump with respect to the trap in the exhaust pipe.

5. The dry vacuum pump regeneration apparatus according to claim 1, further comprising a differential exhaust valve or a flow control valve disposed in the bypass pipe.

6. The dry vacuum pump regeneration apparatus according to claim 1,
wherein the plasma generator includes a conductive pipe, an electrode disposed in the pipe, and a circuit that applies a high frequency voltage between the pipe and the electrode.

7. The dry vacuum pump regeneration apparatus according to claim 1, further comprising:
a second gas heating device configured to cause the second gas to pass through the second gas heating device independently of the first gas heating device, heat the passing second gas, and release the heated second gas to the exhaust port of the stopped dry vacuum pump via the exhaust pipe.

8. The dry vacuum pump regeneration apparatus according to claim 1, further comprising:
an exhaust gas detoxifying device disposed on an exhaust port side of the auxiliary vacuum pump and configured to detoxify a gas discharged from the dry vacuum pump via the auxiliary vacuum pump.

9. The dry vacuum pump regeneration apparatus according to claim 1, further comprising:
a control circuit configured to perform control for switching between a process for releasing the heated second gas to the stopped dry vacuum pump and a process for releasing the radical of the first gas to the stopped dry vacuum pump.

10. The dry vacuum pump regeneration apparatus according to claim 9,
wherein the control circuit is further configured to perform control for restarting the stopped dry vacuum pump.

11. A dry vacuum pump regeneration method, comprising:
releasing a heated inert gas to an intake port of a stopped dry vacuum pump;
releasing the heated inert gas to an exhaust port of the stopped dry vacuum pump; and
releasing a radical of a cleaning gas generated by a plasma to the intake port of the stopped dry vacuum pump.

12. The dry vacuum pump regeneration method according to claim 11,
wherein releasing of the heated inert gas to the intake port of the dry vacuum pump, releasing of the heated inert gas to the exhaust port of the dry vacuum pump, and releasing of the radical of the cleaning gas generated by the plasma to the intake port of the dry vacuum pump are performed after the dry vacuum pump is detached from a pipe that connects the stopped dry vacuum pump to a process chamber.

13. The dry vacuum pump regeneration method according to claim 12,
wherein releasing of the heated inert gas to the intake port of the dry vacuum pump, releasing of the heated inert gas to the exhaust port of the dry vacuum pump, and releasing of the radical of the cleaning gas generated by the plasma to the intake port of the dry vacuum pump are performed while the detached dry vacuum pump is evacuated by an auxiliary vacuum pump connected to the exhaust port of the dry vacuum pump via an exhaust pipe.

14. The dry vacuum pump regeneration method according to claim 13, further comprising:
bypassing between the intake port and the exhaust port of the dry vacuum pump when performing at least one of releasing of the heated inert gas to the intake port of the dry vacuum pump or releasing of the radical of the cleaning gas generated by the plasma to the intake port of the dry vacuum pump.

15. The dry vacuum pump regeneration method according to claim 11,
wherein releasing of the heated inert gas to the exhaust port of the dry vacuum pump is performed after releasing of the heated inert gas to the intake port of the dry vacuum pump.

16. The dry vacuum pump regeneration method according to claim 11, further comprising:
confirming whether or not the dry vacuum pump is restarted between releasing of the heated inert gas to the intake port and/or the exhaust port of the dry vacuum pump and releasing of the radical of the cleaning gas generated by the plasma to the intake port of the dry vacuum pump,
wherein when the dry vacuum pump is not restarted, at least one of releasing of the heated inert gas to the intake port and/or the exhaust port of the dry vacuum pump or releasing of the radical of the cleaning gas generated by the plasma to the intake port of the dry vacuum pump is further performed.

17. The dry vacuum pump regeneration method according to claim 11,
wherein the inert gas is an N₂ gas.

18. The dry vacuum pump regeneration method according to claim 11,
wherein the radical is an F-radical.

19. The dry vacuum pump regeneration method according to claim 11,
wherein releasing of the heated inert gas to the intake port of the dry vacuum pump includes releasing of the inert gas heated to about 200° C. to 300° C.

20. The dry vacuum pump regeneration method according to claim 11,
wherein releasing of the heated inert gas to the exhaust port of the dry vacuum pump includes releasing of the inert gas heated to about 200° C. to 300° C.
